(19) United States
(12) Patent Application Publication
(10) Pub. No.: US 2011/0211549 A1
(43) Pub. Date: Sep. 1, 2011

(54) MULTIPLE ACCESS COMMUNICATION SYSTEM

(75) Inventors: Kwok Shum Edward Au, Singapore (SG); Zhongding Lei, Singapore (SG); Po Shin Francois Chin, Singapore (SG)

(73) Assignee: AGENCY FOR SCIENCE, TECHNOLOGY AND RESEARCH, Singapore (SG)

(21) Appl. No.: 13/128,763

(22) PCT Filed: Nov. 6, 2009
(86) PCT No.: PCT/SG09/00409

§ 371 Date: May 11, 2011

Related U.S. Application Data
(60) Provisional application No. 61/113,687, filed on Nov. 12, 2008.

(51) Int. Cl. H04W 72/04

(52) U.S. Cl. 370/329

(57) ABSTRACT

A multiple access communication system is disclosed herein. In a described embodiment, there is disclosed a method of allocating system bandwidth of the communication system and the method comprises, at step (402), dividing the system bandwidth of the multiple access communication system to form resource blocks amongst which there is one or more pairs symmetric at a carrier frequency; at step (404), assigning a value to each resource block based on the channel qualities and the correlation between the resource block and its counterpart resource block symmetric to the carrier frequency; and at step (406), the symmetric resource blocks are mapped to form respective resource groups based on the values for allocation to respective mobile devices for signal transmission.

### FIELD AND BACKGROUND OF THE INVENTION

This invention relates to a multiple access communication system, particularly but not exclusively, to method and device for allocating system bandwidth of the multiple access communication system.

Conventional orthogonal frequency division multiplexing (OFDM) systems generally employ a super-heterodyne architecture in which the up/down converters operate in a digital domain. A simple representation of the conversion is: Baseband→IF (Intermediate Frequency)→RF (Radio Frequency). This is performed so that the in-phase/quadrature-phase (I/Q) modulation/demodulation may be perfectly performed.

In order to reduce the number of components required in the modulation/demodulation process and thus lower cost requirements, an alternative to the super-heterodyne architecture was developed. This is the zero-intermediate frequency (Zero-IF) architecture, otherwise known as direct conversion architecture, in which the RF signal is directly converted to baseband, and vice versa, in the analog domain. In other words, Basedband→RF and vice versa. While this low-cost alternative has the advantage of reduced hardware complexity, a major drawback to it is the introduction of I/Q imbalance. Generally speaking, there are two types of I/Q imbalances and the difference lies in whether it is a function of frequency or otherwise, i.e. frequency-independent and frequency-dependent. The source and modeling of these two types of I/Q imbalances are quite different. The former, frequency-independent I/Q imbalance, is a result of hardware inaccuracy in the local oscillator and is modeled by a phase mismatch and an amplitude mismatch. The latter, frequency-dependent I/O imbalance, is introduced by front-end components (including low noise amplifiers, low pass filters and analog/digital converters) and is modeled as a time impulse response mismatch on the I and Q branches. These mismatches not only attenuate the desired signal, but also introduce inter-carrier interference on the other subcarriers and amplify noise.

Much recent work has been focused on the design of efficient estimation and compensation algorithms for transmit and receive I/Q imbalances in various settings, especially in the context of single-antenna OFDM systems. These prior contributions to the field are based on the understanding that transmit and receive I/Q imbalances are channel impairments that degrade the signal quality and system performance and that interferences generated by the imbalances should be suppressed.

### SUMMARY OF THE INVENTION

In general terms, the present invention proposes a resource block allocation method and apparatus which exploits the I/Q imbalances to achieve diversity gain. In other words, the invention makes use of the I/Q imbalances rather than attempts to mitigate or suppress the imbalances.

According to a first specific expression of the invention, there is provided a method of allocating system bandwidth of a multiple access communication system to a plurality of communication devices, the method comprising, (i) dividing at least part of the system bandwidth to form resource blocks amongst which there is one or more pairs of the resource blocks symmetric to a carrier frequency; (ii) selectively allocating the one or more resource block pairs to one or respective ones of the plurality of communication devices.

With the proposed method as described in the detailed description, this enables the described embodiment to exploit any I/Q imbalance in the signal to achieve diversity gain.

There may only be one pair of resource block to be allocated to two or more communication devices, for example. In this case, it is still required to select which of the two or more devices are allocated the resource block pair. It is also envisaged that the two or more communication devices share the resource block pair. For example, at one time, one of the communication devices makes use of the resource block pair and at another time, another communication device makes use of the resource block pair. In this way, this ensures that the communication devices are allocated a pair of resource block in order to exploit any I/Q imbalance to achieve diversity gain.

Preferably, the resource blocks comprise a plurality of frequency bands. The resource blocks in the one or more resource block pairs may comprise a contiguous band of frequencies, or they may comprise one or more non-contiguous bands of frequencies.

Advantageously, the method is used for more than one resource block pairs to be allocated. In this case, the method may comprise assigning the resources blocks of each resource block pair with a value based on at least one of: channel quality of the resource blocks and correlation of the symmetric resource blocks of the resource block pair. The method may also include allocating each resource block pairs based on the assigned values. In the alternative, it is envisaged that not all the resource block pairs assigned with values are allocated in pair to users. For example, if the system bandwidth comprises four resource blocks forming two pairs of resource blocks, it is envisaged that one of the pairs are allocated to a user (based on the assigned values) while the other pair may be allocated in a convention manner, for example with each resource block assigned to a user. Thus, at least one of the assigned resource blocks is allocated, and may not be all.

As an alternative, the method may comprise the step of allocating a resource block pair from the more than one resource block pairs which is closer to the edges of the system bandwidth to one of the plurality of communication devices which produce signals with greater in-phase/quadrature phase imbalances (I/Q imbalances).

In a further alternative, the method may further comprise, prior to step (i), grouping the plurality of communication devices based on how their corresponding signals are converted for transmission. The method may further comprise the step of grouping selected ones of the plurality of communication devices as a first group if the corresponding signals are converted directly from baseband to radio frequency; and grouping selected ones of the plurality of communication devices as a second group if the corresponding signals are converted based on the super-heterodyne architecture; and allocating the plurality of resource block pairs based on the groupings.

Preferably, the first group is allocated resource block pairs near the edge of the bandwidth to be allocated.

The entire system bandwidth may be divided in step (i). Alternatively, only a portion of the system bandwidth is divided and allocated based on the above method, and the other portion is allocated to communication devices in a conventional manner. This may be regarded as a “hybrid” allocation method.

The plurality of communication devices may use OFDM for signal transmission.

The methods discussed above may be used by a base station for communication with a plurality of communication devices, such as in a cellular network or other communications network.

In a second specific expression of the invention, there is provided a method of processing signals for a receiver of a communication device, the communication device being one of a plurality of communication devices in a multiple access communication system having a system bandwidth, at least part of the system bandwidth being divided to form resource blocks amongst which there is one or more pairs of resource blocks symmetric to a carrier frequency which are allocated to one or respective ones of the plurality of communication devices, the communication device being allocated a first resource block pair from the one or more resource block pairs, the method comprising the steps of:

receiving the signals which are carried in the one or more resource block pairs, the received signals including signals intended for the plurality of communication devices;

demapping the received signals to extract signals only from the allocated first resource block pair; and

recovering originals signals for the communication device based on the demapped signals.

The first resource block pair may comprise a contiguous band of frequencies. The recovering step may include processing of the signal by one of: a maximum likelihood (ML) detector, an ordered successive interference cancellation (OSIC) detector, or an iterative detector.

A communication device may be configured to communicate with a base station according to the method of the second specific expression of the above features.

A communication network may use the above methods during uplink or downlink communication or more generally for signal transmission. It is also envisaged that the method may be implemented as an integrated circuit which forms the third and fourth specific expressions of the invention as follows:

In a third specific expression of the invention, there is provided an integrated circuit (IC) for a multiple access communication system configured for allocating system bandwidth of the communication system, the IC comprising:

(i) a processing unit configured to divide at least part of the system bandwidth to form resource blocks amongst which there is one or more pairs of the resource blocks symmetric to a carrier frequency, selectively allocating the one or more resource block pairs to one or respective ones of the plurality of communication devices. Such an IC may be used in a base station.

In a fourth specific expression of the invention, there is provided an integrated circuit (IC) for a multiple access communication system configured for processing signals for a receiver of a communication device, the communication device being one of a plurality of communication devices in a multiple access communication system having a system bandwidth, at least part of the system bandwidth being divided to form resource blocks amongst which there is one or more pairs of resource blocks symmetric to a carrier frequency which are allocated to one or respective ones of the plurality of communication devices, the communication device being allocated a first resource block pair from the one or more resource block pairs, the IC comprising

a processing unit configured to receive the signals which are carried in the one or more of the resource block pairs, the received signals including signals intended for the plurality of communication devices; demap the received signals to extract signals only from the allocated first resource block pair; and

recover originals signals for the communication device based on the demapped signals. Such an IC may be used in a communication device.

### BRIEF DESCRIPTION OF THE DRAWINGS

In order that the invention may be fully understood and readily put into practical effect there shall now be described by way of non-limitative example only, an exemplary embodiment of which the description is provided below with reference to the accompanying illustrative drawings in which:

FIG. 1 is a schematic diagram showing a part of an OFDM transmitter for transmitting a complex signal which has transmit I/Q imbalance;

FIG. 2 is a graph showing average minimum Euclidean distances of a first data subcarrier and a single subcarrier counterpart;

FIG. 3 is a graph showing average BERs for 16-QAM modulation of various detection schemes in a frequency selective channel;

FIG. 4 is a graph showing the average BERs for QPSK modulation of the detection schemes of FIG. 3 in a typical urban channel;

FIG. 5 is a graph showing average BERs for 16-QAM modulation of the detection schemes of FIG. 3 in an AWGN channel;

FIG. 6 is a block diagram showing various components of a SC-FDMA system for the uplink of 3GPP LTE-A with sub-carrier mapping or pairing to exploit the I/Q imbalance of a transmitted signal;

FIGS. 7a and 7b illustrate known resource allocation methods;

FIG. 7c illustrates a resource allocation method according to the preferred embodiment of the present invention;

FIG. 8 illustrates an existing LFDMA and clustered SC-FDMA resource block allocation mapping;

FIG. 9 is a flow chart illustrating the steps for allocating resources according to the preferred embodiment of this invention;

FIG. 10 is a graph showing Peak-to-Average Power Ratio (PAPR) characteristics of various resource block allocation schemes with a pulse shaping filter;

FIG. 11 is a graph showing Peak-to-Average Power Ratio (PAPR) characteristics of various resource block allocation schemes without a pulse shaping filter;

FIG. 12 is a graph showing average BER performance of a mobile terminal at a cell edge in the uplink of 3GPP LTE-A.

### DETAILED DESCRIPTION OF THE PREFERRED EMBODIMENT

To appreciate the advantages and benefits of the preferred embodiment, it would be appropriate to begin with a general system which has I/Q imbalances. This will be followed by a performance analysis section studying the impact of the transmit I/Q imbalance on the minimum Euclidean distance properties of an optimal maximum likelihood detector (MLD) with and without I/Q-based subcarrier pairing. Next, the I/Q-based subcarrier pairing is applied to an uplink of Third Generation Partnership Project Long Term Evolution-Advanced (3GPP LTE-A).

I) System Model with Transmit I/Q Imbalance

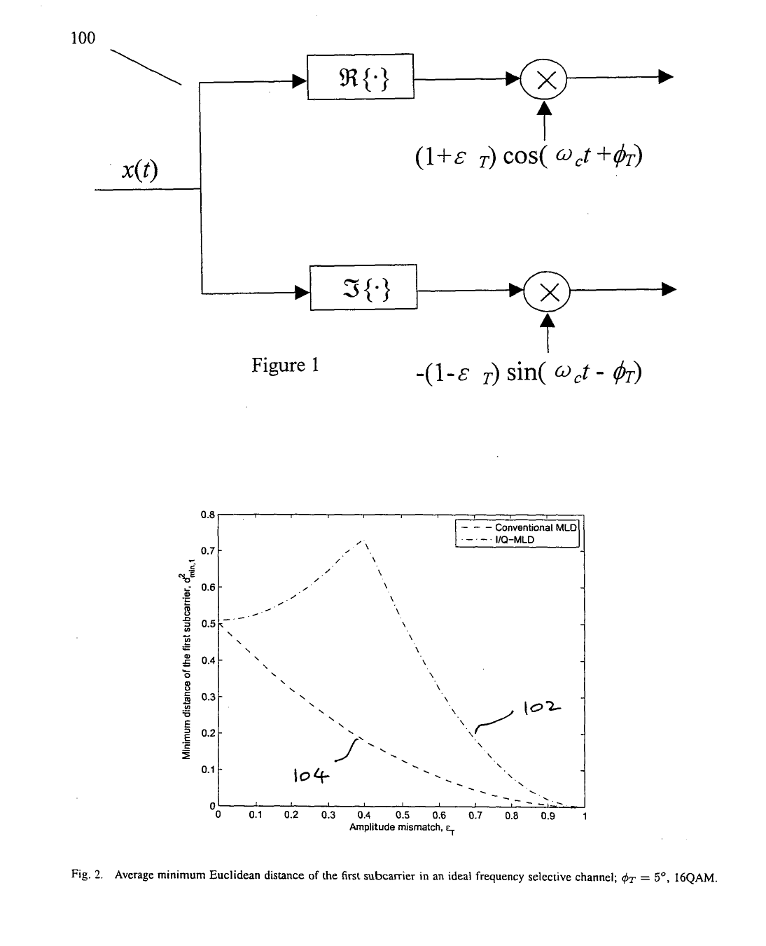

FIG. 1 shows a system model and in this embodiment, this is a complex signal transmission part 100 of a single-antenna OFDM transmitter (not shown) with N subcarriers. In the ideal scenario, without any transmit I/Q imbalance, the RF transmit signal χ_{RF}(t) is expressed in terms of the baseband transmit signal x(t) in the following way.

$$\begin{matrix}{x}_{RF} ( t ) = \{ x ( t ) exp ( {jω}_{c} t ) \} \\ = \{ ( \{ x ( t ) \} + j \{ x ( t ) \} ) ( cos ( {ω}_{c} t ) + jsin ( {ω}_{c} t ) ) \} \\ = \{ x ( t ) \} cos ( {ω}_{c} t ) - \{ x ( t ) \} sin ( {ω}_{c} t ) ,\end{matrix} \qquad ( 1 )$$

where [symbol] {x(t)} and [symbol] {x(t)} are the real and imaginary components of x(t), respectively, and ω_{c}is the carrier frequency.

In the presence of frequency-independent transmit I/Q imbalance, however, the RF transmit signal suffers from an amplitude mismatch ε_{T} and a phase mismatch φ_{T} as shown in FIG. 1. Equation (1) may then be modified to become

x_{RF}(t)= [symbol] {x(t)}(1+ε_{T})cos(ω_{c}t+φ_{T})− [symbol] {x(t)}(1−ε_{T})sin(ω_{c}t−φ_{T}),

and its baseband equivalent is given by

$$\begin{matrix}{x}_{BB} ( t ) = LPF \{ {x}_{RF} ( t ) exp ( - {jω}_{c} t ) \} \\ = \{ x ( t ) \} ( 1 + {ε}_{T} ) cos ( {φ}_{T} ) + \{ x ( t ) \} ( 1 - {ε}_{T} ) sin ( {φ}_{T} ) + \\ j \{ x ( t ) \} ( 1 + {ε}_{T} ) sin ( {φ}_{T} ) + j \{ x ( t ) \} ( 1 - {ε}_{T} ) cos ( {φ}_{T} ) ,\end{matrix} \qquad ( 2 )$$

where LPF{•} is the low pass filter operation that removes any replicas at ±2ω_{c}. As a remark, for the purposes of this embodiment, the amplitude and phase mismatches are constrained such that 0≦ε_{T}≦1 and 0≦φ_{T}≦π/4.

Equation (2) can be further simplified by using the fact that

[symbol]

{x(t)}=(x(t)+x*(t))/2 and [symbol] {x(t)}=−j(x(t)−x*(t))/2

where (•)* is the complex conjugate transpose. This result in

x_{BB}(t)=α_{T}x(t)+β_{T}x*(t),

where α_{T} [symbol] cos φ_{T}+jε_{T} sin φ_{T} and β_{T} [symbol] ε_{T} cos φ_{T}+j sin φ_{T}. The corresponding frequency-domain baseband equivalent transmit signal on the kth subcarrier is given by

$$\begin{matrix}{X}_{BB} [ k ] = {α}_{T} X [ k ] + {β}_{T} {X}^{*} [ - k ] \\ = {α}_{T} X [ k ] + {β}_{T} {X}^{*} [ N - k - 1 ] .\end{matrix} \qquad ( 3 )$$

where k=N₀, N₀+1 . . . N₀+K−2, N₀+K−1, N₀+K+1, N₀+K+2 . . . N₀+2K. It is noted that we have assumed, as in most if not all multicarrier systems the total subcarriers available for data transmission is an even number 2K starting from the N₀th subcarrier. The center frequency, or direct current (DC) subcarrier, N₀+K is not used for data transmission.

From equation (3), it can be observed that X[k] is interfered by the signal of the image subcarrier, X[N−k−1].

For X[k], X[N−k−1]ε [symbol] , where [symbol] is a set of all possible elements of a modulation alphabet, the polar coordinate representation is considered such that the representation takes value from one of the M complex constellation points that are equi-probable, but with different amplitudes μₖ(m) and phases φₖ(m), i.e.,

X[k]=μₖ(m)exp(jφₖ(m))

where ε{|X[k]|²}=Σₘ₌₁^{M} μₖ²(m)/M=1 for all k, m=1, 2, . . . , M, k=N₀, N₀+1 . . . N₀+K−2, N₀+K−1, N₀+K+1, N₀+K+2, N₀+2K+1, and ε{•} is the expectation operator.

Let Y_{BB}[k] denote the baseband equivalent receive signal. It is expressed in terms of equation (3) as follows.

$$\begin{matrix}{Y}_{BB} [ k ] = H [ k ] {X}_{BB} [ k ] + W [ k ] \\ = \underbrace{{α}_{T} H [ k ] X [ k ]}_{desired signal} + \underbrace{{β}_{T} H [ k ] {X}^{*} [ N - k - 1 ] + W [ k ]}_{image signal and noise} ,\end{matrix} \qquad ( 4 )$$

where H[k] is the channel coefficient of the k-th subcarrier and it is modeled as an independent and identically distributed (i.i.d.) complex Gaussian random variable with zero mean and variance σₕ²[k]. Also, W[k] is the additive white Gaussian noise (AWGN) of the subcarrier k and it is an i.i.d. complex Gaussian random variable with zero mean and variance σ_{w}² . Further, H[k] and W[k] are independent with each other. From equation (5), it is clear that the received signal consists of not only the desired subcarrier scaled by α_{T} , but also the image subcarrier scaled by β_{T}.

In order to quantify the effect of these mismatches, consider the image rejection ratio (IRR), given by:

$$\begin{matrix}IRR = \frac{{\vert {α}_{T} \vert}^{2}}{{\vert {β}_{T} \vert}^{2}} \\ = \frac{{cos}^{2} {φ}_{T} + {ε}_{T}^{2} {sin}^{2} {φ}_{T}}{{ε}_{T}^{2} {cos}^{2} {φ}_{T} + {sin}^{2} {φ}_{T}} .\end{matrix} \qquad ( 5 )$$

In an ideal scenario without transmit I/Q imbalance, i.e., ε_{T}=φ_{T}=0, IRR is of infinite value. In practice, the IRR value depends on the applications of interest, and the typical value ranges from 30 dB to 80 dB.

Another alternative is to consider the receive signal-to-interference-plus-noise ratio (SINR). Conditioned on the channel coefficient H[k] and the amplitudes of constellation symbols of the image subcarrier μ_{N-k-1}(m′), where m′=1, 2, . . . , M, the sum of the image signal and noise in equation (5) is a zero-mean complex Gaussian variable with variance |β_{T}H[k]|²μ_{N-k-1}²(m′)+σ_{w}². The receive SINR for one particular realization of μₖ(m), i.e., the amplitude of one of the M constellation symbols of X[k], is given by

$${SINR}_{k} ( {μ}_{k} ( m ) \vert {μ}_{N - k - 1} ( {m}^{′} ) , H [ k ] ) = \frac{{\vert {α}_{T} H [ k ] \vert}^{2} {μ}_{k}^{2} ( m )}{{\vert {β}_{T} H [ k ] \vert}^{2} {μ}_{N - k - 1}^{2} ( {m}^{′} ) + {σ}_{w}^{2}} = \frac{( {cos}^{2} {φ}_{T} + {ε}_{T}^{2} {sin}^{2} {φ}_{T} ) {\vert H [ k ] \vert}^{2} {μ}_{k}^{2} ( m )}{( {ε}_{T}^{2} {cos}^{2} {φ}_{T} + {sin}^{2} {φ}_{T} ) {\vert H [ k ] \vert}^{2} {μ}_{N - k - 1}^{2} ( {m}^{′} ) + {σ}_{w}^{2}} . \qquad ( 6 )$$

Asymptotically, when σ_{w}²→0, equation (6) becomes

$${lim}_{{σ}_{w}^{2} \to 0} {SINR}_{k} ( {μ}_{k} ( m ) \vert {μ}_{N - k - 1} ( {m}^{′} ) , H [ k ] ) = \frac{( {cos}^{2} {φ}_{T} + {ε}_{T}^{2} {sin}^{2} {φ}_{T} ) {μ}_{k}^{2} ( m )}{( {ε}_{T}^{2} {cos}^{2} {φ}_{T} + {sin}^{2} {φ}_{T} ) {μ}_{N - k - 1}^{2} ( {m}^{′} )} .$$

Referring to the above asymptotical expression, it can be observed that when ε_{T}≠0 and φ_{T}≠0, the conditional SINR does not approach an infinite value. In other words, there is a ceiling/cap on the SINR in the presence of transmit I/Q imbalance. Furthermore, μₖ²(m)=μ_{N-k-1}²(m′) for all m and m′, the asymptotic SINR is equivalent to the IRR in equation (4).

Although it is clear from equation (6) that in the presence of the transmit I/Q imbalance, the achievable SINR performance is capped by a ceiling as the noise variance σ_{w}² decreases, however, the next section will show analytically that with some proper receiver processing, the system performance can be unexpectedly improved significantly.

II) Performance Analysis

In the article by Y. Jin, J. Kwon, Y. Lee, J. Ahn, W. Choi and D. Lee “Obtaining diversity gain coming from IQ imbalance under carrier frequency offset in OFDM-based systems” in Proceedings of IEEE VTC Spring, April 2007, pp. 2175-2179 [Jin et. al.], it was proposed by simulations that when a received signal of a desired subcarrier is processed by proper receiver processing, such as the maximum likelihood detector (MLD), together with that of the image subcarrier in frequency selective fading channels, diversity gain can be obtained.

However, the teachings in Jin et. al. are just simulations.

To provide an understanding of the benefits of the described embodiment, the following passages will discuss the minimum Euclidean distance properties of, and evaluating the transmit diversity order of, an optimal maximum likelihood detector with an I/Q-based subcarrier pairing (i.e., the pairing of the desired subcarrier and its image subcarrier) as proposed by the present invention. The results are then compared with the transmit diversity orders of a conventional single subcarrier-based MLD (i.e. without any subcarrier pairing) and a zero forcing (ZF) detector with the same subcarrier pairing.

Maximum Likelihood Detector with I/Q-based Subcarrier Pairing (I/Q-MLD)

As referred to in equation (5), the baseband received signal of the k-th subcarrier Y_{BB}[k] is a function of the transmit signal of its own subcarrier X[k] and that of an image subcarrier X[N−k−1]. If Y_{BB}[k] is paired with the complex conjugate transpose of the baseband receive signal of the (N−k−1)-th subcarrier Y*_{BB}[N−k−1] in the following way,

$$\underbrace{[ \begin{matrix}{Y}_{BB} [ k ] \\ {Y}_{BB}^{*} [ N - k - 1 ]\end{matrix} ]}_{{=}^{Δ} {Y}_{k}} = \underbrace{[ \begin{matrix}{α}_{T} H [ k ] & {β}_{T} H [ k ] \\ {β}_{T}^{*} {H}^{*} [ N - k - 1 ] & {α}_{T}^{*} {H}^{*} [ N - k - 1 ]\end{matrix} ]}_{{=}^{Δ} {H}_{k}} \underbrace{[ \begin{matrix}X [ k ] \\ {X}^{*} [ N - k - 1 ]\end{matrix} ]}_{{=}^{Δ} {X}_{k}} + \underbrace{[ \begin{matrix}W [ k ] \\ {W}^{*} [ N - k - 1 ]\end{matrix} ]}_{{=}^{Δ} {W}_{k}} , \qquad ( 7 )$$

then one can observe from equation (7) that since the two transmit symbols, X[k], X*[N−k−1], are transmitted across two different subcarriers simultaneously, transmit diversity is potentially provided in a frequency selective fading channel.

Based on the technique proposed by E. Soljanin and C. N. Georghiades “Multihead detection for multitrack recording channels”; IEEE Transactions on Information Theory, vol. 44, no. 7, pp 2988-2997, November 1998, a minimum Euclidean distance analysis of an optimal MLD with the I/Q-based subcarrier pairing of equation (7) is carried out, i.e.

$${\hat{X}}_{k} = arg {min}_{{X}_{k}} {‖ {Y}_{k} - {H}_{k} {X}_{k} ‖}^{2} , \qquad ( 8 )$$

where \hat{X}ₖ=[\hat{X}[k], \hat{X}*[N−k−1]]^{T} is the estimate of Xₖ, and (•)^{T} is the transpose. For the ease of reference, throughout this description, we refer to this MLD as “I/Q-MLD”.

The fundamental importance of considering the minimum Euclidean distance is that the bit error rate (BER) at high signal-to-noise ratio (SNR) is well approximated by the equation:

$$P ( {\hat{X}}_{k} = {X}_{k} \vert {H}_{k} ) \approx \frac{η}{{log}_{2} M} Q ( \sqrt{v \frac{{d}_{min , k}^{2}}{{σ}_{w}^{2}}} ) , \qquad ( 9 )$$

and the transmit diversity order, which refers to the magnitude of the slope of the average BER versus SNR curve at high SNR, can be easily evaluated according to the equation:

$$Transmit Diversity Order = {lim}_{{σ}_{w}^{2} \to 0} - \frac{log P ( {\hat{X}}_{k} = {X}_{k} \vert {H}_{k} )}{log {σ}_{w}^{- 2}} , \qquad ( 10 )$$

where η and υ are constellation-dependent parameters, Q(•) is the standard Q-function, and d_{min,k}² is the minimum distance expression of the I/Q-MLD, which is obtained by the minimization of the squared Euclidean distance d²(Eₖ) over all possible non-zero normalized error events

$${E}_{k} = {X}_{k} - {\hat{X}}_{k} = {[ E [ k ] , {E}^{*} [ N - k - 1 ] ]}^{T} ∈ M , i . e . \\ {d}_{min , k}^{2} = {min}_{{E}_{k} \neq 0} {d}^{2} ( {E}_{k} ) .$$

In the following results, there is an assumption that complete composite channel state information (CSI) Hₖ (i.e., the channel state information H[k], H[N−k−1], the amplitude mismatch ε_{T}, and the phase mismatch φ_{T}) is known at the receiver.

Theorem 1:

Let

$${d}_{0}^{2} = {min}_{E [ k ] \neq 0} {‖ E [ k ] ‖}^{2} = {min}_{E [ N - k - 1 ] \neq 0} {‖ E [ N - k - 1 ] ‖}^{2} . \qquad ( 11 )$$

For a particular phase mismatch φ_{T}, the minimum Euclidean distance of the I/Q-MLD is expressed in terms of the amplitude mismatch ε_{T} as follows.

$${d}_{min , k}^{2} = \{ \begin{matrix}( \begin{matrix}( {cos}^{2} {φ}_{T} + {ε}_{T}^{2} {sin}^{2} {φ}_{T} ) {\vert H [ k ] \vert}^{2} + \\ ( {ε}_{T}^{2} {cos}^{2} {φ}_{T} + {sin}^{2} {φ}_{T} ) {\vert H [ N - k - 1 ] \vert}^{2}\end{matrix} ) {d}_{v}^{2} , & 0 \leq {ε}_{T} \leq c ( {φ}_{T} ) \\ {( 1 - {ε}_{T} )}^{2} ( {\vert H [ k ] \vert}^{2} + {\vert H [ N - k - 1 ] \vert}^{2} ) {d}_{0}^{2} , & c ( {φ}_{T} ) \leq {ε}_{T} \leq 1 ,\end{matrix} \\ where \\ c ( {φ}_{T} ) = \frac{- b \pm \sqrt{{b}^{2} - 4 ac}}{2 a} , with \\ a = {\vert H [ N - k - 1 ] \vert}^{2} {sin}^{2} {φ}_{T} + {\vert H [ k ] \vert}^{2} {cos}^{2} {φ}_{T} , \\ b = - 2 ( {\vert H [ k ] \vert}^{2} + {\vert H [ N - k - 1 ] \vert}^{2} ) , and \\ c = {\vert H [ N - k - 1 ] \vert}^{2} {cos}^{2} {φ}_{T} + {\vert H [ k ] \vert}^{2} {sin}^{2} {φ}_{T} . \qquad ( 12 )$$

Proof of Theorem 1:

By re-arranging equation (7) as

Yₖ^{T}=Xₖ^{T}Hₖ^{T}+Wₖ^{T},

the squared Euclidean distance can be expressed as

$$\begin{matrix}{d}^{2} ( {E}_{k} ) = {‖ {E}_{k}^{T} {H}_{k}^{T} ‖}^{2} \\ = ( {\vert {α}_{T} \vert}^{2} {\vert H [ k ] \vert}^{2} + {\vert {β}_{T} \vert}^{2} {\vert H [ N - k - 1 ] \vert}^{2} ) {‖ E [ k ] ‖}^{2} + \\ ( {\vert {α}_{T} \vert}^{2} {\vert H [ N - k - 1 ] \vert}^{2} + {\vert {β}_{T} \vert}^{2} {\vert H [ k ] \vert}^{2} ) {‖ E [ N - k - 1 ] ‖}^{2} + \\ {α}_{T} {β}_{T}^{*} ( {\vert H [ k ] \vert}^{2} + {\vert H [ N - k - 1 ] \vert}^{2} ) ( ‖ E [ k ] ‖ ) ( ‖ E [ N - k - 1 ] ‖ ) + \\ {α}_{T}^{*} {β}_{T} ( {\vert H [ k ] \vert}^{2} + {\vert H [ N - k - 1 ] \vert}^{2} ) ( ‖ {E}^{*} [ k ] ‖ ) ( ‖ {E}^{*} [ N - k - 1 ] ‖ ) .\end{matrix} \qquad ( 13 )$$

Without loss of generality, it is assumed that

|α_{T}|²|H[N−k−1]|²+|β_{T}|²|H[k]|²≧|α_{T}|²|H[k]|²+|β_{T}|²|H[N−k−1]|², (14)

which is equivalent to

$${\vert H [ k ] \vert}^{2} \leq {\vert H [ N - k - 1 ] \vert}^{2} , 0 \leq {ε}_{T} \leq 1 , and 0 \leq {φ}_{T} \leq \frac{π}{4} .$$

In order to find the minimum distance d_{min,k}², the set of all possible non-zero error vectors Eₖ=[E[k], E*[N−k−1]]^{T} is partitioned into the following two cases.

Case 1: One Non-Zero Error Element

In this case, either E[k]≠0, i.e.,

d²(Eₖ)=(|α_{T}|²|H[k]|²+|β_{T}|²|H[N−k−1]|²)∥E[k]∥²,

or E*[N−k−1]≠0, which corresponds to

d²(Eₖ)=(|α_{T}|²|H[N−k−1]|²+|β_{T}|²|H[k]|²)∥E[N−k−1]∥².

If a common assumption is made that the single-subcarrier minimum Euclidean distance is the same for both subcarriers, i.e., min∥E[k]∥²=min∥E[N−k−1]∥²=d₀² as in equation (11) then it is clear from equation (14) that the minimum distance for the case of one non-zero error element is given by

$$\begin{matrix}{d}_{min , k}^{2} = ( {\vert {α}_{T} \vert}^{2} {\vert H [ k ] \vert}^{2} + {\vert {β}_{T} \vert}^{2} {\vert H [ N - k - 1 ] \vert}^{2} ) {d}_{0}^{2} \\ = ( \begin{matrix}( {cos}^{2} {φ}_{T} + {ε}_{T}^{2} {sin}^{2} {φ}_{T} ) {\vert H [ k ] \vert}^{2} + \\ ( {ε}_{T}^{2} {cos}^{2} {φ}_{T} + {sin}^{2} {φ}_{T} ) {\vert H [ N - k - 1 ] \vert}^{2}\end{matrix} ) {d}_{0}^{2} .\end{matrix}$$

In other words, the minimum Euclidean distance is achieved when ∥E[k]∥²=d₀².

Case 2: Two Non-Zero Error Elements

In this case, both elements of Eₖ are non-zero, i.e., E[k], E*[N−k−1]≠0. Given equation (13), one can lower-bound it in the following way:

$$\begin{matrix}{d}^{2} ( {E}_{k} ) = ( {\vert {α}_{T} \vert}^{2} {\vert H [ k ] \vert}^{2} + {\vert {β}_{T} \vert}^{2} {\vert H [ N - k - 1 ] \vert}^{2} ) E [ k ] {E}^{*} [ k ] + \\ ( {\vert {α}_{T} \vert}^{2} {\vert H [ N - k - 1 ] \vert}^{2} + {\vert {β}_{T} \vert}^{2} {\vert H [ k ] \vert}^{2} ) \\ E [ N - k - 1 ] {E}^{*} [ N - k - 1 ] + \\ {α}_{T} {β}_{T}^{*} ( {\vert H [ k ] \vert}^{2} + {\vert H [ N - k - 1 ] \vert}^{2} ) E [ k ] E [ N - k - 1 ] + \\ {α}_{T}^{*} {β}_{T} ( {\vert H [ k ] \vert}^{2} + {\vert H [ N - k - 1 ] \vert}^{2} ) {E}^{*} [ k ] {E}^{*} [ N - k - 1 ] \geq \\ ( {\vert {α}_{T} \vert}^{2} {\vert H [ k ] \vert}^{2} + {\vert {β}_{T} \vert}^{2} {\vert H [ N - k - 1 ] \vert}^{2} ) {‖ E [ k ] ‖}^{2} + \\ ( {\vert {α}_{T} \vert}^{2} {\vert H [ N - k - 1 ] \vert}^{2} + {\vert {β}_{T} \vert}^{2} {\vert H [ k ] \vert}^{2} ) {‖ E [ N - k - 1 ] ‖}^{2} - \\ {α}_{T} {β}_{T}^{*} ( {\vert H [ k ] \vert}^{2} + {\vert H [ N - k - 1 ] \vert}^{2} ) \vert E [ k ] E [ N - k - 1 ] \vert - \\ {α}_{T}^{*} {β}_{T} ( {\vert H [ k ] \vert}^{2} + {\vert H [ N - k - 1 ] \vert}^{2} ) \vert {E}^{*} [ k ] {E}^{*} [ N - k - 1 ] \vert \geq \\ ( {\vert {α}_{T} \vert}^{2} {\vert H [ k ] \vert}^{2} + {\vert {β}_{T} \vert}^{2} {\vert H [ N - k - 1 ] \vert}^{2} ) {‖ E [ k ] ‖}^{2} + \\ ( {\vert {α}_{T} \vert}^{2} {\vert H [ N - k - 1 ] \vert}^{2} + {\vert {β}_{T} \vert}^{2} {\vert H [ k ] \vert}^{2} ) {‖ E [ N - k - 1 ] ‖}^{2} - \\ {α}_{T} {β}_{T}^{*} ( {\vert H [ k ] \vert}^{2} + {\vert H [ N - k - 1 ] \vert}^{2} ) \vert E [ k ] \vert \vert E [ N - k - 1 ] \vert - \\ {α}_{T}^{*} {β}_{T} ( {\vert H [ k ] \vert}^{2} + {\vert H [ N - k - 1 ] \vert}^{2} ) \vert {E}^{*} [ k ] \vert \vert {E}^{*} [ N - k - 1 ] \vert ,\end{matrix} \qquad ( 15 )$$

in which the equality equation (15) is achieved when E[k]=−E*[N−k−1]. By considering the following inequality

$$\vert E [ k ] \vert \vert E [ N - k - 1 ] \vert \leq \frac{1}{2} ( {‖ E [ k ] ‖}^{2} + {‖ E [ N - k - 1 ] ‖}^{2} ) ,$$

Equation (15) can further be lower-bounded as

$$\begin{matrix}{d}^{2} ( {E}_{k} ) \geq ( {\vert {α}_{T} \vert}^{2} {\vert H [ k ] \vert}^{2} + {\vert {β}_{T} \vert}^{2} {\vert H [ N - k - 1 ] \vert}^{2} ) {‖ E [ k ] ‖}^{2} + \\ ( {\vert {α}_{T} \vert}^{2} {\vert H [ N - k - 1 ] \vert}^{2} + {\vert {β}_{T} \vert}^{2} {\vert H [ k ] \vert}^{2} ) {‖ E [ N - k - 1 ] ‖}^{2} - \\ \frac{1}{2} {α}_{T} {β}_{T}^{*} ( {\vert H [ k ] \vert}^{2} + {\vert H [ N - k - 1 ] \vert}^{2} ) \\ ( {‖ E [ k ] ‖}^{2} + {‖ E [ N - k - 1 ] ‖}^{2} ) - \\ \frac{1}{2} {α}_{T}^{*} {β}_{T} ( {\vert H [ k ] \vert}^{2} + {\vert H [ N - k - 1 ] \vert}^{2} ) \\ ( {‖ E [ k ] ‖}^{2} + {‖ E [ N - k - 1 ] ‖}^{2} ) . \\ \geq ( {\vert {α}_{T} \vert}^{2} {\vert H [ k ] \vert}^{2} + {\vert {β}_{T} \vert}^{2} {\vert H [ N - k - 1 ] \vert}^{2} ) {d}_{0}^{2} + \\ ( {\vert {α}_{T} \vert}^{2} {\vert H [ N - k - 1 ] \vert}^{2} + {\vert {β}_{T} \vert}^{2} {\vert H [ k ] \vert}^{2} ) {d}_{0}^{2} - \\ ( {α}_{T} {β}_{T}^{*} + {α}_{T}^{*} {β}_{T} ) ( {\vert H [ k ] \vert}^{2} + {\vert H [ N - k - 1 ] \vert}^{2} ) {d}_{0}^{2} \\ = ( {\vert {α}_{T} - {β}_{T} \vert}^{2} ) ( {\vert H [ k ] \vert}^{2} + {\vert H [ N - k - 1 ] \vert}^{2} ) {d}_{0}^{2} . \\ = {( 1 - {ε}_{T} )}^{2} ( {\vert H [ k ] \vert}^{2} + {\vert H [ N - k - 1 ] \vert}^{2} ) {d}_{0}^{2} .\end{matrix} \qquad ( 16 )$$

Note here that the inequality equation (15) is achieved when E[k]=−E*[N−k−1], and the inequality equation (16) is achieved when ∥E[k]∥²=∥E[N−k−1]∥²=d₀².

Finally, the resulting minimum distance expression equation (12) can be obtained by combining the lower bounds in the two cases above.

Intuitively, one would expect from, for example, the SINR expression in equation (6) that the presence of the transmit I/Q imbalance leads to performance degradation. Interestingly and unexpectedly, as referred to in the resulting minimum Euclidean distance expression equation (12) in Theorem 1, it is observed that the minimum distance increases (or equivalently, the average BER improves) with the amplitude mismatch ε_{T} until the turning point at ε_{T}=c(φ_{T}) is reached.

Given the analytical results derived in Theorem 1, the following shows the effect of the amplitude and phase mismatches on the transmit diversity order.

Corollary 1

In the presence of the transmit I/Q imbalance, the transmit diversity order of the I/Q-MLD is equal to two.

Proof of Corollary 1

At high SNR, it is clear from equation (9) that the conditional BER decreases exponentially with d_{min,k}²/σ_{w}². Due to the fact that |H[k]|² and |H[N−k−1]|² are chi-squared random variables of degree 1, d_{min,k}² is a weighted chi-square variable of degree 2, which corresponds to a slope of two in the average BER versus SNR curve, and a value of two in equation (10).

It is important to note that, in general, the diversity gain provided by the transmit I/Q imbalance is highly dependent on the following two factors.
F1) The scaling factor β_{T}. If the value of β_{T} is very small, or equivalently if the effects of the amplitude and phase mismatches are not significant, then the impact of |β_{T}|²|H[N−k−1]|² on d_{min,k}² is negligible. In this case, one would expect that the diversity gain is very small and the performance of the I/Q-MLD would approach the ideal scenario without transmit I/Q imbalance.
F2) The correlation between H[k] and H*[N−k−1]. Denote

$$\begin{matrix}{ρ}_{k} = \frac{ɛ \{ H [ k ] {H}^{*} [ N - k - 1 ] \}}{\sqrt{ɛ \{ {\vert H [ k ] \vert}^{2} \} ɛ \{ {\vert H [ N - k - 1 ] \vert}^{2} \}}} \\ = \frac{ɛ \{ H [ k ] {H}^{*} [ N - k - 1 ] \}}{{σ}_{h} [ k ] {σ}_{h} [ N - k - 1 ]}\end{matrix} \qquad ( 1 )$$

as a complex-valued and normalized correlation coefficient between H[k] and H*[N−k−1]. It is clear that if these two channel coefficients are highly uncorrelated, i.e., ρₖ→0, then the potential gain due to the image subcarrier is very large. Generally speaking, ρₖ decreases with the delay spread.

Corollary 2

Consider the AWGN channel as a special case. In the presence of transmit I/Q imbalance, the resulting minimum Euclidean distance of the I/Q-MLD is expressed as*

$${d}_{min , k}^{2} = \{ \begin{matrix}( 1 + {ε}_{T}^{2} ) {d}_{0}^{2} , & when 0 \leq {ε}_{T} \leq 2 - \sqrt{3} \\ 2 {( 1 - {ε}_{T} )}^{2} {d}_{0}^{2} , & when 2 - \sqrt{3} \leq {ε}_{T} \leq 1.\end{matrix} \qquad ( 17 )$$

Proof of Corollary 2

The proof of equation (17) follows trivially from the fact that |H[k]|²=H[N−k−1]|²=1 for all k.

Referring to Corollary 2, it is found that, despite the absence of the frequency diversity, there is an increase in the power gain due to the additional amount of energy, ε_{T}², contributed from the amplitude mismatch to the I/Q-MLD. In addition, it can be observed that the minimum distance equation (17) depends only on the amplitude mismatch ε_{T}, but not the phase mismatch φ_{T}, in the AWGN channel.

Single Subcarrier-Based Maximum Likelihood Detector (without Sub-Carrier Pairing)

The performance of the I/Q-MLD with a conventional single subcarrier-based MLD (i.e. without sub-carrier pairing) is compared to the above. Without loss of generality, it is assumed that |H[k]|²≦|H[N−k−1]|². The squared Euclidean distance is given by

$$\begin{matrix}{d}^{2} ( {E}_{k} ) = {‖ [ E [ k ] {E}^{*} [ N - k - 1 ] ] [ \begin{matrix}{α}_{T} H [ k ] \\ {β}_{T} H [ k ]\end{matrix} ] ‖}^{2} \\ = ( \begin{matrix}{\vert {α}_{T} \vert}^{2} {‖ E [ k ] ‖}^{2} + {\vert {β}_{T} \vert}^{2} {‖ E [ N - k - 1 ] ‖}^{2} + \\ {α}_{T} {β}_{T}^{*} E [ k ] E [ N - k - 1 ] + {α}_{T}^{*} {β}_{T} {E}^{*} [ k ] {E}^{*} [ N - k - 1 ]\end{matrix} ) \\ {\vert H [ k ] \vert}^{2} .\end{matrix} \qquad ( 18 )$$

The minimum distance d_{min,k}² is obtained by the minimization of d²(Eₖ) in equation (18) over all possible non-zero error events, i.e., [E[k]E*[N−k−1]]≠0, and it is given by

$$\begin{matrix}{d}_{min , k}^{2} = ( {\vert {α}_{T} - {β}_{T} \vert}^{2} ) {\vert H [ k ] \vert}^{2} {d}_{0}^{2} \\ = {( 1 - {ε}_{T} )}^{2} {\vert H [ k ] \vert}^{2} {d}_{0}^{2}\end{matrix} \qquad ( 19 )$$

Similar to the I/Q-MLD, the minimum is achieved when E[k]=−E*[N−k−1] and ∥E[k]∥²=∥E[N−k−1]∥²=d₀².

For the special case of the AWGN channel, equation (19) is simplified as

d²(Eₖ)=(1−ε_{T})²d₀². (20)

From equation (19) and equation (20), it is observed that the minimum Euclidean distance of the conventional single subcarrier-based MLD is only a function of the amplitude mismatch, and it decreases at a rate that is squarely proportional to E_{T}, which is in contrast to the analytical conclusion made in the previous subsection that the minimum distance of the I/Q-MLD is increased for certain values of the transmit I/Q imbalance. Further, it is clear from equation (9) and equation (10) that no transmit diversity is offered in this case.

Zero Forcing Detector with I/Q-Based Subcarrier Pairing (I/Q-ZFD)

For the purpose of comparison, a sub-optimal but low-complexity zero forcing (ZF) detector Hₖ⁻¹ with the same subcarrier pairing equation (7) is also considered,

$${H}_{k}^{- 1} = \frac{1}{( {\vert {α}_{T} \vert}^{2} - {\vert {β}_{T} \vert}^{2} ) H [ k ] {H}^{*} [ N - k - 1 ]} [ \begin{matrix}{α}_{T}^{*} {H}^{*} [ N - k - 1 ] & - {β}_{T} H [ k ] \\ - {β}_{T}^{*} {H}^{*} [ N - k - 1 ] & {α}_{T} H [ k ]\end{matrix} ] . \qquad ( 21 )$$

Pre-multiplying equation (21) with the receive signal vector Yₖ yields the ZF estimate of Xₖ:

$$\begin{matrix}{\hat{X}}_{k} = {H}_{k}^{- 1} {Y}_{k} \\ = {X}_{k} + {H}_{k}^{- 1} {W}_{k} .\end{matrix}$$

The corresponding instantaneous post-detection SINR of the k-th subcarrier is then expressed as

$$γ [ k ] = \frac{ɛ \{ {\vert X [ k ] \vert}^{2} \}}{{[ {Q}_{k} ]}_{1 , 1}} = {[ {Q}_{k} ]}_{1 , 1}^{- 1} , \qquad ( 22 )$$

where [Qₖ]_{i,j,} is the (i,j)-th entry of Qₖ, which is the noise covariance conditioned on Hₖ⁻¹, and it is given by

$$\begin{matrix}{Q}_{k} = ɛ \{ {H}_{k}^{- 1} {W}_{k} {{W}_{k}^{*} ( {H}_{k}^{- 1} )}^{*} \} \\ = {σ}_{ω}^{2} {{H}_{k}^{- 1} ( {H}_{k}^{- 1} )}^{*} . \\ = \frac{{σ}_{ω}^{2}}{{( {\vert {α}_{T} \vert}^{2} - {\vert {β}_{T} \vert}^{2} )}^{2} {\vert H [ k ] \vert}^{2} {\vert H [ N - k - 1 ] \vert}^{2}} \\ [ \begin{matrix}\begin{matrix}{\vert {α}_{T} \vert}^{2} {\vert H [ N - k - 1 ] \vert}^{2} + \\ {\vert {β}_{T} \vert}^{2} {\vert H [ k ] \vert}^{2}\end{matrix} & - {α}_{T}^{*} {β}_{T} {\vert H [ N - k - 1 ] \vert}^{2} - {α}_{T}^{*} {β}_{T} {\vert H [ k ] \vert}^{2} \\ \begin{matrix}- {α}_{T} {β}_{T}^{*} {\vert H [ N - k - 1 ] \vert}^{2} - \\ {α}_{T} {β}_{T}^{*} {\vert H [ k ] \vert}^{2}\end{matrix} & {\vert {β}_{T} \vert}^{2} {\vert H [ N - k - 1 ] \vert}^{2} + {\vert {α}_{T} \vert}^{2} {\vert H [ k ] \vert}^{2}\end{matrix} ] .\end{matrix}$$

Due to the fact that 0≦|α_{T}|², |β_{T}|²≦1, [Qₖ]_{1,1}⁻¹ in equation (22) can be upper-bounded as follows.

$$\begin{matrix}{[ {Q}_{k} ]}_{1 , 1}^{- 1} \leq \frac{{σ}_{ω}^{2}}{2 min \{ {\vert {α}_{T} \vert}^{2} , {\vert {β}_{T} \vert}^{2} \}} \frac{2 {\vert H [ N - k - 1 ] \vert}^{2} {\vert H [ k ] \vert}^{2}}{( {\vert H [ N - k - 1 ] \vert}^{2} + {\vert H [ k ] \vert}^{2} )} \leq \\ \frac{1}{4 min \{ {\vert {α}_{T} \vert}^{2} , {\vert {β}_{T} \vert}^{2} \}} ( {\vert H [ k ] \vert}^{2} + {\vert H [ N - k - 1 ] \vert}^{2} ) \\ {=}^{Δ} {γ}_{UB , k} .\end{matrix} \qquad ( 23 )$$

Since |H[k]² and |H[N−k−1]|² are chi-squared random variables of degree 1, γ_{UB,k} should be a chi-square variable of degree 2. In other words, the I/Q-ZFD provides, at a maximum, an additional degree of transmit diversity with respect to the ideal scenario without the transmit I/Q imbalance. However, the equality in equation (22) can only be achieved when |α_{T}|²=|β_{T}|² and |H[k]|²=|H[N−k−1]|² , i.e., when both subcarriers experience flat fading channels. Therefore, the I/Q-ZFD can at most provide performance improvement in terms of the power gain, rather than the diversity gain, and approaches the performance of the ideal scenario without transmit I/Q imbalance.

Numerical Results

Monte Carlo simulation methods are provided to evaluate the performance of the I/Q-MLD with respect to the single subcarrier-based counterpart and the sub-optimal but low-complexity I/Q-ZFD. The performances of the ideal scenario without I/Q imbalance and the worst-case scenario that the transmit I/Q imbalance is being ignored at the receiver, i.e. neither compensation/cancellation nor subcarrier pairing is done, are also compared. The simulation parameters as shown in Table I. This is purely by way of example, and other configurations and parameters may be considered.

TABLE I
Simulation Parameters

| Parameter | Value |
|---|---|
| Carrier frequency | 2 GHz |
| Transmission | 10 MHz |
| bandwidth | |
| Channel model | (a) random frequency selective channel; |
| | (b) 3GPP typical urban area propagation model; |
| | (c) AWGN channel |
| Number of subcarriers, | 1024 |
| N | |
| Modulation format | QPSK, 16QAM |
| Amplitude mismatch, | ε_{T} = 0.26, 0.3 |
| ε_{T} | |
| Phase mismatch, φ_{T} | ε_{T} = 0°, 5° |
| Others | (a) Perfect composite CSI Hₖ given in equation |
| | (7) |
| | (b) No channel coding |

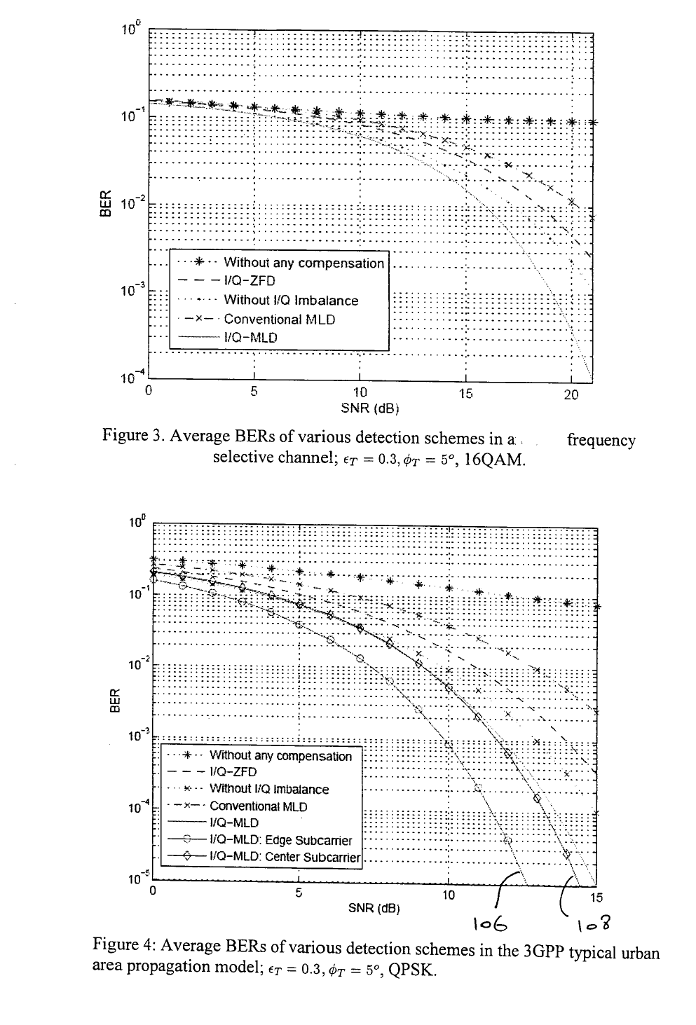

For a first example, the impact of the transmit I/Q imbalance on the three detection schemes in an ideal frequency selective channel with ρₖ=0 for all subcarriers is observed. FIG. 2 shows the minimum Euclidean distance of a first data subcarrier d_{min,1}² 102, which is averaged over 100000 channel realizations. It would be appreciated from FIG. 2 that the minimum distance of the I/Q-MLD first increases with ε_{T}, followed by decreasing rapidly with ε_{T} when the maximum is reached at ε_{T}=0.40. These observations agree with the analytical results derived in Theorem 1. In addition, it should be appreciated that I/Q-MLD 102 outperforms the single subcarrier counterpart 104 for various values of ε_{T}. For example, when ε_{T}=0.3, the minimum distance is increased significantly from 0.2456 to 0.6463 when the subcarrier pairing equation (7) is used. With such an increase in the minimum distance, one can expect that, as evident in FIG. 3, the I/Q-MLD yields a significant reduction in the average BER.

Further, it is observed from the figure that the slope of the average BER versus SNR curve at high SNR is larger for the I/Q-MLD, which is also consistent with the analytical conclusion given in Corollary 1 that diversity gain is being provided.

In summary, with the proper subcarrier pairing, the transmit I/Q imbalance can improve the system performance. For example, when SNR=20 dB, the BERs of the conventional MLD and without transmit I/Q imbalance are about 1.1×10⁻² and 2.4×10⁻³, respectively. When the subcarrier pairing equation (7) is considered, the BERs improve significantly to 4.8×10⁻³ and 3.9×10⁻⁴, respectively, for the ZF detector and the MLD.

Next, the average BER performance of these detection schemes in a realistic typical urban area propagation model is investigated and a twenty-tap multipath channel that is widely considered in 3GPP LTE-A is used (see for example: Third Generation Partnership Project (3GPP): Technical Specification Group Radio Access Network: Requirements for Further Advancements for E-UTRA (LTE-Advanced)(Release 8). [Online—http://www.3gpp.org/ftp/Specs/html-info/36913.htm].

FIG. 4 is a graph showing the average system performance of the detection schemes of FIG. 3 and also those of an edge subcarrier pair 106 and a center subcarrier pair 108. It should be appreciated from FIG. 4 that the edge subcarrier pair 106 outperforms the center subcarrier pair 108 by about 2 dB at moderate-to-high SNRs. This observation is explained by the remark (F2) earlier that the correlation ρₖ increases when the paired subcarriers are getting closer to one another. Further, it is observed that the slope of the average BER versus SNR curve for the I/Q-MLD is similar to that for the ideal scenario without transmit I/Q imbalance (i.e., the I/Q-MLD contributes mainly the power gain, rather than the diversity gain to the system). This observation can also be explained by F2 (see earlier section) that, when compared with the ideal frequency selective channel, the delay spread is smaller because of the limited number of multipaths in the realistic channel model considered here. It should be mentioned that only bit errors on those carriers are counted to show that edge subcarriers have better performance due to higher channel variation.

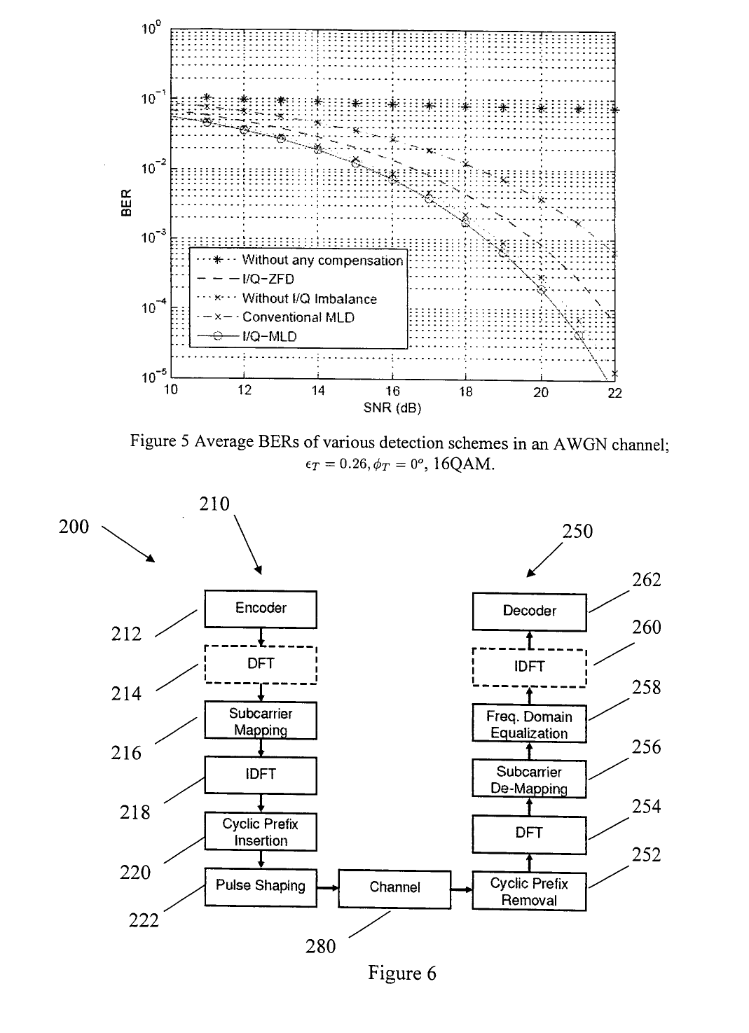

Finally the special case of an AWGN channel is also considered. FIG. 5 is a graph showing the average BERs of the three detection schemes of FIG. 3 in an AWGN channel. The I/Q-MLD provides only a slight improvement with respect to the ideal scenario without transmit I/O imbalance. This result is consistent with the analytical results derived in Corollary 2, that in the absence of the frequency diversity, the minimum Euclidean distance barely increases by an amount of ε_{T}² (in this case, ε_{T}²=0.0676), which is too small to bring a significant reduction in the average BER. Nevertheless, it still significantly outperforms the conventional MLD by about 3 dB.

The above principles will now be applied to 3GPP.

III) Application of Subcarrier Pairing to 3GPP LTE-A

In this example, the I/Q-based subcarrier pairing equation (7) is applied to 3GPP LTE-A uplink as an advantageous alternative to existing resource block allocation strategies.

It would be appropriate to begin with some background. Single-carrier frequency division multiple access (SC-FDMA), utilizes single carrier modulation and sequential transmission at the mobile terminal's transmitter side as well as frequency-domain equalization (FDE) at the base station's receiver side, and is an extension of the classical SC/FDE technique to accommodate multiple access. Due to its inherent single-carrier structure, SC-FDMA signals have a lower Peak-to-Average Power Ratio (PAPR) than those of the orthogonal frequency division multiple access (OFDMA), which means that the power transmission efficiency of the mobile terminals is increased, and the area coverage can in turn be extended. Due to the fact that the provisioning of wide area coverage is more important than the demand for a higher data rate in 3GPP LTE-A, SC-FDMA is preferred to OFDMA as an uplink multiple access scheme.

FIG. 6 is a block diagram showing various components of a SC-FDMA system 200 for the uplink of 3GPP LTE-A. Briefly, the system 200 includes a transmission section 210, a receiving section 250 and a transmission channel 280 communicatively linking the transmission section 210 and the receiving section 250. The transmission section 210 includes an encoder 212 for encoding a signal according to a transmission scheme, a Discrete Fourier Transform (DFT) module 214 for converting the signal from time domain into frequency domain, a Subcarrier Mapping module 216 for processing the converted signal from the DFT module 214 and an Inverse DFT (IDFT) module 218 for receiving the signal from the subcarrier mapping module 216. After the inverse DFT, a Cyclic Prefix Insertion module 220 inserts the necessary padding (i.e. cyclic prefix) and a Pulse Shaping module 222 filters the signal so that the signal is suitable for transmission via the transmission channel 280.

In one example, the transmission section 210 may be part of a base station of a cellular network for example, and the receiving section 250 may be included in each communication device operating in the cellular network. The communication device may be mobile telephones, computers or other mobile devices. Of course, it may not be a cellular network but other wireless communication networks are envisaged.

At the receiving section 250, the reverse steps take place and the receiving section 250 includes a Cyclic Prefix Removal module 252 for removing the padding from the received signal, a DFT module 254 for converting the received signal to the frequency domain, a Sub-Carrier De-Mapping module 256 and a Frequency Domain Equalization module 258 to change the frequency response of the signal so that it is suitable for the next process. After the Frequency Domain Equalization module 258, there is an IDFT 260 to convert the signal back to the time domain and a decoder 262 to obtain the original transmitted signal.

From FIG. 6, it should be appreciated that the system 200 is very similar to an OFDMA system except that the time-domain input data symbols are transformed to frequency domain by the DFT module 214, followed by the subcarrier mapping module 216 before performing the OFDMA modulation. In other words, for OFDMA, it is not necessary to have the DFT module 214 and the IDFT module 260. Note that SC-FDMA is also termed as DFT-spread OFDMA. It is the same as OFDMA in that it suffers from similar transmit I/Q imbalance during the baseband-to-RF conversion.

The various blocks of the system 200 are known (and thus, not necessary to elaborate on these blocks), except the sub-carrier mapping module 216 and the sub-carrier de-mapping module 256. The following discussion will thus be focused on these two modules 216,256.

Subcarrier Mapping/Resource Block Allocation

The main purpose of subcarrier mapping is to allocate DFT-precoded input data of different mobile terminals to data subcarriers (or resource blocks) over the entire system bandwidth. However, for systems with large numbers of mobile terminals and subcarriers such as 3GPP LTE-A, the computational complexity involved in individual subcarrier allocation is very huge. Therefore, the basic scheduling unit for both the uplink and downlink bandwidth is one resource block (RB), which consists of several consecutive subcarriers. Specifically, in 3GPP LTE-A, one RB comprises either 12 consecutive subcarriers with a subcarrier bandwidth of 15 kHz or 24 consecutive subcarriers with a subcarrier bandwidth of 7.5 kHz.

In 3GPP LTE-A, several resource block mapping approaches are presently used. Two of these include localized subcarrier mapping and clustered resource block mapping. For the ease of notational description, they are referred to as LFDMA and Clustered SC-FDMA (CL-SC-FDMA), respectively.

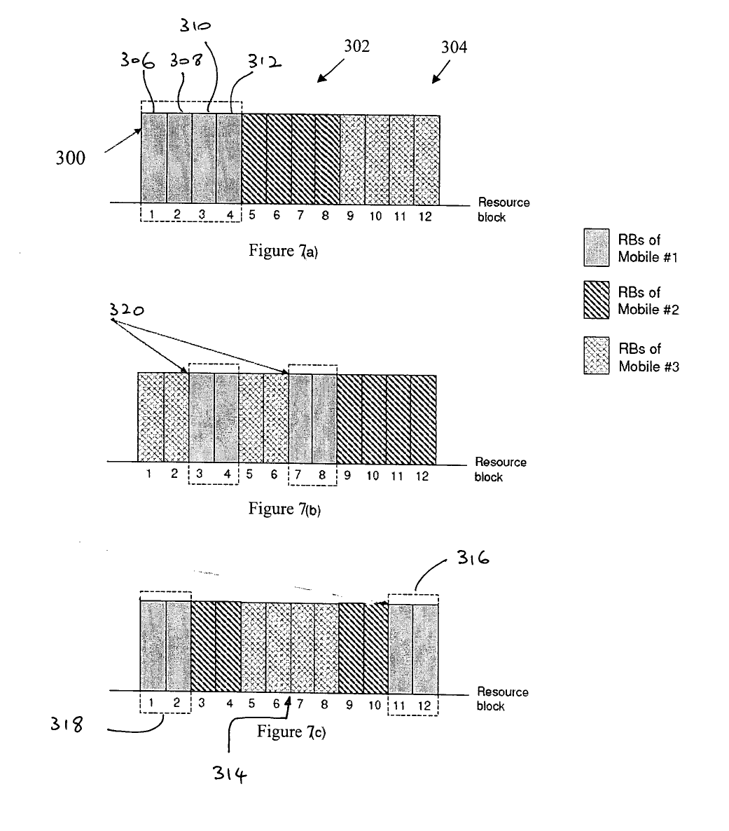

For LFDMA, all DFT-precoded input data of a mobile terminal is mapped onto consecutive resource blocks (RBs). An illustrative example of LFDMA is shown in FIG. 7(a) which has three mobile terminals or devices 300,302,304. Here, the input data of mobile #1 300 are mapped onto 4 contiguous RBs 306,308,310,312 that are confined to a continuous fraction of system bandwidth. The same applies for mobiles #2 and #3 302,304 under this scheme.

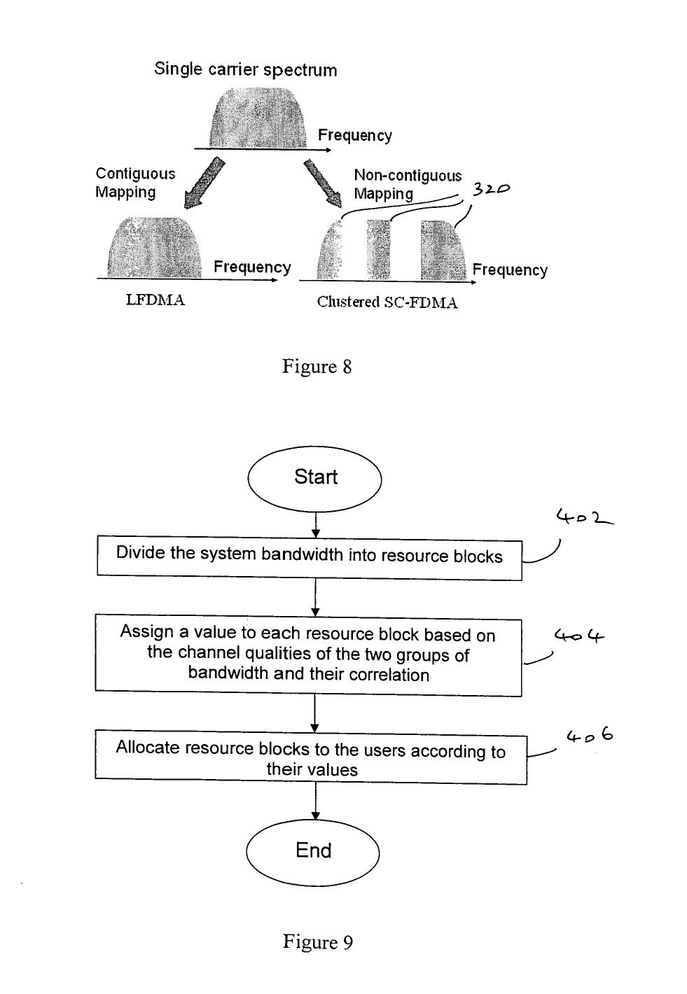

As an alternative to LFDMA, CL-SC-FDMA has been proposed. FIG. 8 shows an illustrative comparison between the resource block allocation methods of LFDMA and CL-SC-FDMA. In contrast to the LFDMA, the precoded data of CL-SC-FDMA is mapped onto multiple clusters 320, each consisting of consecutive RBs. An example is of CL-SC-FDMA is shown in FIG. 7(b), in which each cluster 320 comprises two consecutive RBs. The cluster allocation to each mobile terminal is highly dependent on the scheduling policy and the availability of frequency resources. Using this example, while the two non-contiguous clusters (one with RBs #1 and #2, another with RBs #5 and #6) are allocated to mobile #3, the two contiguous clusters (i.e., RBs #9 to #12) are allocated to mobile #2. Note that LFDMA is actually a special case of CL-SC-FDMA where each mobile only has one cluster. When compared with the LFDMA, it is clear that CL-SC-FDMA provides a larger degree of uplink scheduling flexibility and improves the frequency diversity by, for example, allocating clusters of RBs that are in favorable channel conditions for a mobile terminal over the entire system bandwidth. However, CL-SC-FDMA has its shortcomings and one problem is that it tends to favor mobile terminals that are closer to the base stations. For those terminals that are located near the cell edge, the potential frequency diversity gain may be minimal because of the poor channel condition.

To address the above shortcomings, it is proposed to allocate resources according to the preferred embodiment of the present invention, and the steps are shown in FIG. 9.

At step 402, the system bandwidth is divided to form a plurality of resource blocks. It is preferred in the division that each of the resource blocks can be paired with another one of the resource blocks that is symmetrical to a carrier or centre frequency. FIG. 7(c) illustrates how the resources are allocated for an I/Q-imbalance based CL-SC-FDMA scheme. The carrier frequency 314 between resource blocks #6 and #7 of FIG. 7(c) is corresponding to a DC subcarrier which is not shown in the figure as it is a null subcarrier instead of a data subcarrier.

Step 404 then assigns a value to each resource block based on its channel quality and/or correlation of the resource blocks paired. An example of doing this based on correlation of the resource blocks paired is to rank all the resource block pairs according to their correlation and use their ranking of each pair as their values. As an alternative, if the exact correlation of the resource blocks paired is not available, distance of the resource block to the center frequency may be used as the value (called a priority value). The closer the paired resource block is to the centre frequency, the higher is the correlation in general and a lower potential for I/Q imbalance diversity gain (i.e. has a lower priority value).

The mobile terminals (or users) are then allocated resource blocks at step 406 according to the values. For example, a pair of resource blocks with better channel qualities and lower correlation may be given a higher value and allocated to mobile terminals which contain significant I/Q imbalances to maximize the overall system performance.

Instead of steps 404 and 406, there are also other ways of allocating the resource blocks. For example, the resource blocks may be assigned in a symmetrical fashion, clustered or otherwise, to the mobile terminals or communication devices. Furthermore, clustering one or more resource blocks on either side of the symmetry is immaterial, as long as each resource block is correspondingly paired to its symmetrical counterpart on the other side of the symmetry.

The resource blocks may be allocated based on the types of groups. To elaborate, mobile terminals or communication devices may be grouped based on the system architecture. Specifically, the mobile terminals are divided into two or more groups according to which system architecture they use for baseband-to-RF signal conversion. In other words, the grouping is based on how the signals are to be converted for transmission. For those that implement the low-cost Zero-IF architecture and with non-negligible transmit I/Q imbalance, they are placed in a “low-cost group”. In contrast, for those that implement the conventional super-heterodyne architecture with minimal or even negligible I/Q imbalance, they are placed in the “high-end group”.

Based on the analytical results described earlier, it is clear that the system performance of the low-cost group's terminals would be improved, as opposed to being degraded, by the transmit I/Q imbalance if the I/Q-based subcarrier pairing as shown in equation (7) is considered. FIG. 4 also supports this, showing that the system performance of the edge subcarriers is better than that of the centered subcarriers as ρₖ decreases with the spacing between the paired resource block/subcarriers.

Based on the example of cluster allocation being performed in pairs, the low-cost group's terminals are assigned with edge clusters containing symmetric resource blocks, while centered clusters are allocated to the terminals of the other group. To give further examples, based on the assumption that mobiles #1 and #2 belong to the low-cost group while mobile #3 is in the high-end group. From FIG. 7c, it would be appreciated that mobile #1 is assigned with edge clusters with a resource group having four RBs 316,318 which are symmetric to the center frequency, while mobile #2 is allocated with RBs #3, 4, 9 and 10, which is formed by another resource group.

As for mobile #3, since the impact of the transmit I/Q imbalance, and hence the potential achievable diversity gain, is smaller, it is assigned with only the centered clusters (RBs #5 to #8) which forms a further resource group.

By allocating the mobile terminals in the above manner, the low-cost group mobiles are able to take advantage of the I/Q imbalance within their transmitted signals and produce diversity gain. The high-end group remain relatively less affected since their transmitted signals contain insignificant I/Q imbalances and they are allocated resource blocks closer to the center of symmetry—frequencies which would not benefit significantly even if I/Q imbalance was considered.

In the alternative, the resource blocks may be allocated using a hybrid method in allocation steps 404 and 406. For example, the total available frequency band or resource blocks can be divided into two or more groups. Only one or more groups of resources are allocated according to the method described above to explore I/Q imbalance diversity. Other groups of resource blocks can be allocated differently, for example using conventional cluster based techniques.

Demapping Module

At the receiving section 250 of, for example a mobile communication device, the received time domain signals are processed by the Cyclic Prefix Removal module 252 and then converted from time domain to frequency domain by the DFT module 254.

It should be noted that the received time domain signals include signals for all the communication devices within the communication network and thus, the frequency domain signals occupy the entire frequency band and include all signals for all the communication devices.

In each communication device, the demapping module 256 extracts the frequency domain signals belonging to the resource block pair allocated to the specific communication device or user. For example, and referring to FIG. 7c, mobile #1's demapping module 256 is configured to extract or only take signals from resource block pair 316, 318, whereas mobile #2 is configured to extract signals on resource block pair as defined by resource blocks 3,4,9,10.

After the demapping module 256 has extracted the corresponding signals from the allocated resource block pair, the frequency domain equalization module 258 performs equalization on the signals one subcarrier by one subcarrier.

In the alternative, it is preferred to perform joint equalization for 2 or more subcarriers of the resource block pair. As it can be appreciated, the two subcarriers are symmetric to a carrier frequency in order to achieve diversity gain. Maximum likelihood detection (MLD) may be used for the joint detection. If complexity of MLD is of concern, lower complexity equalization/detection such as various near MLD or interference cancellation types or iterative algorithms may be considered.

Finally, the equalized signals are converted back to time domain by IDFT module 260 and decoded by decoder 262 to obtain the original signals.

Numerical Results

The PAPR and the average BER of the uplink 3GPP LTE-A system using various resource block allocation schemes (including OFDMA, LFDMA, Clustered SC-FDMA, and I/Q-based CL-SC-FDMA) based on the resource block mapping are investigated. Table II summarizes the simulation parameters used for a simplified uplink 3GPP LTE-A system which is used to benchmark the various schemes. In the simulation, it is assumed that the cluster/RB allocation to the mobile terminal is performed by the scheduler such that the clusters/RBs chosen are advantageously based on the channel conditions of the mobile terminals.

TABLE II
Simplified Simulation Parameters for 3GPP LTE-A Uplink

| Parameter | Value |
|---|---|
| Carrier frequency | 3.4 GHz |
| Transmission bandwidth | 20 MHz |
| Channel model | 3GPP typical urban area propagation |
| | model |
| Number of subcarriers, N | 2048 |
| Number of RBs per mobile | 40 (480 subcarriers) |
| terminal | |
| Number of clusters | 2 (20 RBs per cluster), 8 (5 RBs per |
| | cluster) |
| Modulation format | QPSK, 16QAM |
| Pulse Shaping Filter for the 3 | Raised cosine filter with a roll□off |
| variants of SC□FDMA | factor of 0.5 |
| Oversampling factor for OFDMA | 8 |
| Amplitude mismatch, ε_{T} | ε_{T} = 0.3 |
| Phase mismatch, φ_{T} | φ_{T} = 5° |
| Others | (a) Perfect composite CSI Hₖ given |
| | in equation (7) |
| | (b) No channel coding |

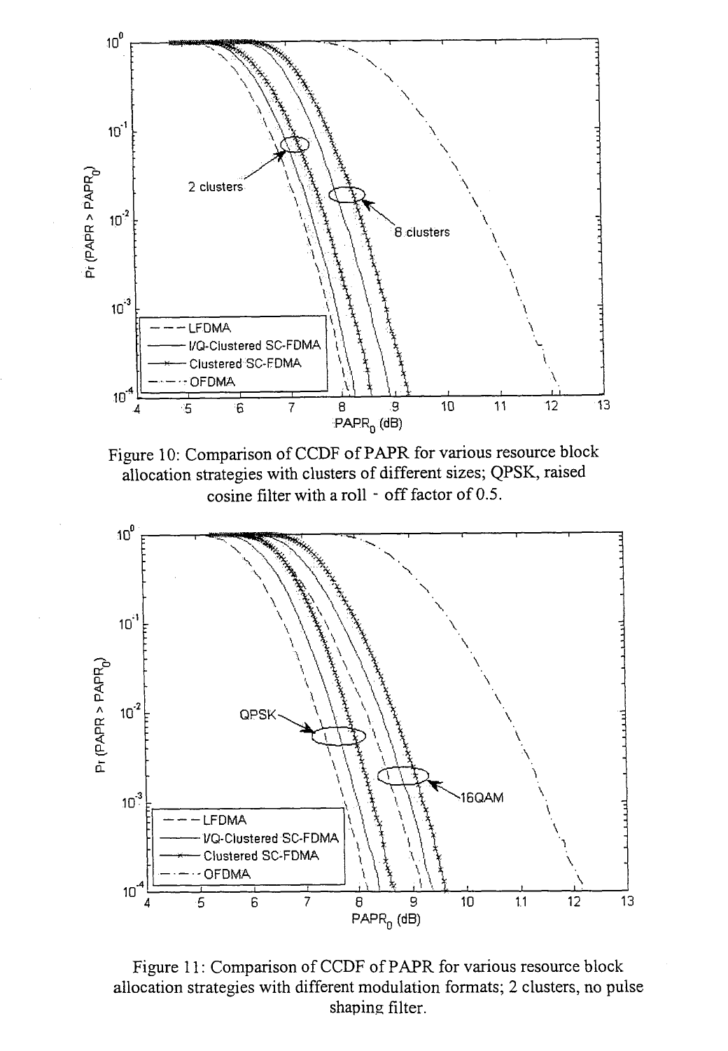

The PAPR characteristics of various resource block allocation schemes are analysed based on their complementary cumulative distribution functions (CCDFs), which refer to the probability that the PAPR is higher than a certain threshold value, PAPR₀. FIGS. 10 and 11 show the CCDFs with and without the implementation of a raised cosine filter as the pulse shaping filter, respectively. The I/Q-imbalance based CL-SC-FDMA has about 0.5 dB and 0.3 dB gains over the CL-SC-FDMA for the 99.9-percentile PAPR when QPSK and 16QAM are used, respectively. The results are consistent with the findings that the PAPR increases with the number of clusters, and there is only a minimal impact of the pulse shaping filter on the PAPR characteristics of LFDMA.

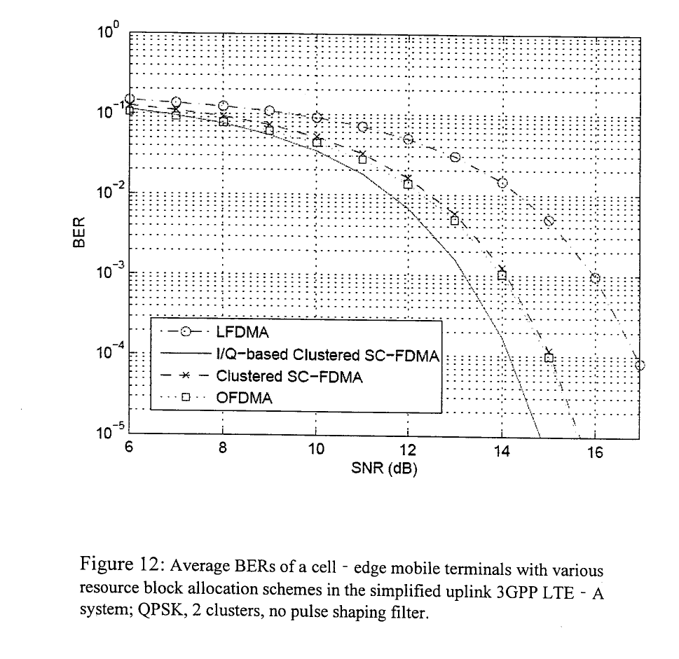

FIG. 12 shows average BER performance of a mobile terminal at the cell edge in 3GPP LTE-A uplink. In the simulations, the I/Q-MLD is used for the I/Q-based CL-SC-FDMA, and the conventional MLD is considered in LFDMA, CL-SC-FDMA, and OFDMA. It is clear from FIG. 12 that the I/Q-imbalance based I/Q-MLD achieves a significant improvement. This is mainly due to the fact that the described embodiment exploits, rather than mitigates, the transmit I/Q imbalance.

Based on the above, it can be seen that the transmit I/Q imbalance on the transmit diversity order has a significant impact on the average BER performance for a single-antenna OFDM system. In particular, the potential gain of the transmit I/Q imbalance can be exploited by considering a joint subcarrier-based maximum likelihood detector that pairs the receive signal of the desired subcarrier with the complex conjugate transpose of its image subcarrier. Using the minimum Euclidean distance analysis, it is shown that the minimum distance increases with the certain range of the amplitude mismatch, and a transmit diversity order of at most 2 can be provided. It is important to note that, however, the achievable diversity gain is highly dependent on the values of the amplitude and phase mismatches, the multipath decay profile, and the correlation of the channel coefficients between the paired subcarriers.

By taking subcarrier pairing into account, the requirements for the RF transceiver subject to the I/Q imbalance may be relaxed. In other words, it is not necessary to fully compensate both the amplitude and phase mismatches if their values fall into a certain range that can maximize the minimum Euclidean distance as derived in Theorem 1 and Corollary 2.

The described embodiment should not be construed as limitative. For example, the described embodiment describes the subcarrier allocation as a method but it would be apparent that the method may be implemented as a device, more specifically as an Integrated Circuit (IC). In this case, the IC may include a processing unit configured to perform the various method steps discussed earlier. Further, in FIGS. 7(a)-(c), mobile devices #1, #2 and #3 are described but other communication devices are envisaged, not just mobile devices. The described embodiment is particularly useful in a cellular network, such as a network adopting 3GPP LTE, but it should be apparent that the described embodiment may also be used in other wireless communication networks for communication of voice and/or data.

The described embodiment discusses that the resource block pairs are symmetric to the carrier frequency or centre frequency. This may be regarded as a “centre” frequency to the resource block pairs and may not be “centre” of the system bandwidth.

Although the described embodiment describes a more than one resource block pairs but there may only be one pair of resource block to be allocated to two communication devices, for example. In this case, it is still required to select which of the two or more devices are allocated the resource block pair. It is also envisaged that the two or more communication devices share the resource block pair. For example, at one time, one of the communication devices makes use of the resource block pair and at another time, another one communication device makes use of the resource block pair. In this way, this ensures that the communication devices are allocated a pair of resource block in order to exploit any I/Q imbalance to achieve diversity gain.

Whilst there has been described in the foregoing description embodiments of the present invention, it will be understood by those skilled in the technology concerned that many variations in details of design, construction and/or operation may be made without departing from scope as claimed.

1. A method of allocating system bandwidth of a multiple access communication system to a plurality of communication devices, the method comprising,
(i) dividing at least part of the system bandwidth to form resource blocks amongst which there is one or more pairs of the resource blocks symmetric to a carrier frequency;
(ii) selectively allocating the one or more resource block pairs to one or respective ones of the plurality of communication devices.

2. A method according to claim 1, wherein the resource blocks comprise a plurality of frequency bands.

3. A method according to claim 1 wherein the resource blocks in the one or more resource block pairs comprises a contiguous band of frequencies.

4. A method according to claim 1, wherein the resource blocks in the one or more resource block pairs comprise one or more non-contiguous bands of frequencies.

5. A method according to claim 1, further comprising more than one resource block pairs.

6. A method according to claim 5, further comprising assigning the resources blocks of each resource block pair with a value based on at least one of: channel quality of the resource blocks and correlation of the symmetric resource blocks of the resource block pair.

7. A method according to claim 6, wherein step (ii) includes allocating at least one of the assigned resource block pair based on the assigned values.

8. A method according to claim 5, further comprising the step of allocating a resource block pair from the more than one resource block pairs which is closer to the edges of the system bandwidth to one of the plurality of communication devices which produce signals with greater in-phase/quadrature phase imbalances (I/Q imbalances).

9. A method according to claim 5, further comprising, prior to step (i), grouping the plurality of communication devices based on how their corresponding signals are converted for transmission.

10. A method according to claim 9, further comprising the step of grouping selected ones of the plurality of communication devices as a first group if the corresponding signals are converted directly from baseband to radio frequency; and grouping selected ones of the plurality of communication devices as a second group if the corresponding signals are converted based on the super-heterodyne architecture; and allocating the plurality of resource block pairs based on the groupings.

11. A method according to claim 9, wherein the first group is allocated resource block pairs near the edge of the bandwith to be allocated.

12. A method according to claim 1, wherein the entire system bandwidth is divided in step (i).

13. A method according to claim 1, wherein the plurality of communication devices uses OFDM for signal transmission.

14. A method of processing signals for a receiver of a communication device, the communication device being one of a plurality of communication devices in a multiple access communication system having a system bandwidth, at least part of the system bandwidth being divided to form resource blocks amongst which there is one or more pairs of resource blocks symmetric to a carrier frequency which are allocated to one or respective ones of the plurality of communication devices, the communication device being allocated a first resource block pair from the one or more resource block pairs, the method comprising the steps of:
receiving the signals which are carried in the one or more resource block pairs, the received signals including signals intended for the plurality of communication devices;
demapping the received signals to extract signals only from the allocated first resource block pair; and
recovering originals signals for the communication device based on the demapped signals.

15. A method according to claim 14 wherein the first resource block pair comprises a contiguous band of frequencies.

16. A method according to claim 14 wherein the recovering step includes processing of the signal by one of: a maximum likelihood (ML) detector, an ordered successive interference cancellation (OSIC) detector, or an iterative detector.

17. A base station configured to communicate with a plurality of communication devices according to the method of claim 1.

18. A communications network configured to communicate according to the method of claim 1 during uplink or downlink communication.

19. A communication device configured to communicate with a base station according to the method of claim 14.

20. An integrated circuit (IC) for a multiple access communication system configured for allocating system bandwidth of the communication system, the IC comprising:
(i) a processing unit configured to divide at least part of the system bandwidth to form resource blocks amongst which there is one or more pairs of the resource blocks symmetric to a carrier frequency, selectively allocating the one or more resource block pairs to one or respective ones of the plurality of communication devices.

21. An integrated circuit (IC) for a multiple access communication system configured for processing signals for a receiver of a communication device, the communication device being one of a plurality of communication devices in a multiple access communication system having a system bandwidth, at least part of the system bandwidth being divided to form resource blocks amongst which there is one or more pairs of resource blocks symmetric to a carrier frequency which are allocated to one or respective ones of the plurality of communication devices, the communication device being allocated a first resource block pair from the one or more resource block pairs, the IC comprising
a processing unit configured to receive the signals which are carried in the one or more of the resource block pairs, the received signals including signals intended for the plurality of communication devices; demap the received signals to extract signals only from the allocated first resource block pair; and
recover originals signals for the communication device based on the demapped signals.

22. A base station comprising an IC according to claim 20.

23. A communication device comprising an IC according to claim 21.
